(19) United States
(12) Patent Application Publication
(10) Pub. No.: US 2020/0143061 A1
(43) Pub. Date: May 7, 2020

(54) METHOD AND APPARATUS FOR TRACKING LOCATION OF INPUT DATA THAT CAUSES BINARY VULNERABILITY

(71) Applicant: KOREA INTERNET & SECURITY AGENCY, Jeollanam-do (KR)

(72) Inventors: Hwan Kuk Kim, Jeollanam-do (KR); Tae Eun Kim, Jeollanam-do (KR); Dae Il Jang, Jeollanam-do (KR); Han Chul Bae, Jeollanam-do (KR); Jong Ki Kim, Jeollanam-do (KR); Soo Jin Yoon, Jeollanam-do (KR); Jee Soo Jurn, Jeollanam-do (KR); Geon Bae Na, Jeollanam-do (KR)

(73) Assignee: KOREA INTERNET & SECURITY AGENCY, Jeollanam-do (KR)

(21) Appl. No.: 16/517,452

(22) Filed: Jul. 19, 2019

(30) Foreign Application Priority Data
Nov. 6, 2018 (KR) 10-2018-0135069

(51) Int. Cl. G06F 21/57; G06F 9/30

(52) U.S. Cl. CPC G06F 21/577; G06F 2221/034; G06F 9/30098

(57) ABSTRACT

There is provided a method of tracking the location of the cause of a binary vulnerability, the method being performed by a computing apparatus and comprising: adding first taint information for a first operand register tainted by input data of an error-causing case, generating second taint information for a second operand register tainted by data of the first operand register by using the first taint information; and tracking input data that caused an error among the input data of the error-causing case by tracing back taint information of a register of each operand from a point where the error occurred.

This application claims the benefit of Korean Patent Application No. 10-2018-0135069, filed on Nov. 6, 2018, in the Korean Intellectual Property Office, the disclosure of which is incorporated herein by reference in its entirety.

### BACKGROUND

### Field

The present disclosure relates to a method of finding data that causes a vulnerability, and more particularly, to a method of finding exact data that causes a vulnerability among external data input to a binary when the vulnerability occurs in the binary due to the external data input to the binary.

### Description of the Related Art

If a vulnerability exists in a binary, an unexpected error occurs when the binary is executed. Examples of the vulnerability include a buffer overflow, an integer overflow, a memory exception, a malformed input, a race condition, a symbolic link, and a null pointer. Due to the vulnerability, some functions of the binary can be tampered with for improper purposes, or a system in which the binary is executed can cause a security problem. Therefore, a vulnerability in a binary executed in a security-critical system should be addressed quickly and accurately.

A binary is often executed by receiving a vast amount of external data. However, at present, even if a vulnerability occurs in the binary, it is difficult to analyze the cause of the vulnerability because it is not possible to find exact data that caused the vulnerability among the vast amount of data. Therefore, it is required to provide a technology that can track the location of exact data that caused a vulnerability in a binary.

### SUMMARY

Aspects of the present disclosure provide a method of finding data that causes a vulnerability in a binary among a vast amount of external data input to the binary.

Aspects of the present disclosure also provide a method of finding a plurality of pieces of data that cause a vulnerability in a binary through a single binary analysis process without the need to analyze the binary a plurality of times when there are the pieces of data that cause the vulnerability.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided a method of tracking the location of the cause of a binary vulnerability, the method being performed by a computing apparatus and comprising: adding first taint information for a first operand register tainted by input data of an error-causing case, generating second taint information for a second operand register tainted by data of the first operand register by using the first taint information, and tracking input data that caused an error among the input data of the error-causing case by tracing back taint information of a register of each operand from a point where the error occurred.

According to another aspect of the present disclosure, there is provided a computing apparatus comprising: a memory into which a binary analysis program is loaded and a processor which executes the binary analysis program loaded into the memory, wherein the binary analysis program comprises: an instruction for adding first taint information for a first operand register tainted by input data of an error-causing case, an instruction for generating second taint information for a second operand register tainted by data of the first operand register by using the first taint information, and an instruction for determining input data that caused an error among the input data of the error-causing case by tracing back taint information of a register of each operand from a point where the error occurred.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram for explaining the operation of a system for tracking the location of the cause of a binary vulnerability according to an embodiment;

FIG. 2 is a flowchart illustrating a method of tracking the location of the cause of a binary vulnerability according to an embodiment;

FIG. 3 is a flowchart illustrating an operation of the method of FIG. 2 in detail;

FIG. 4 is a flowchart illustrating an operation of the method of FIG. 3 in detail;

FIG. 5 is a flowchart illustrating an operation of the method of FIG. 4 in detail;

FIG. 6 is a flowchart illustrating an operation of the method of FIG. 2 in detail;

FIG. 7 is a diagram for explaining a method of generating input data information and taint information in an operand register according to embodiments;

FIG. 8 is a diagram for explaining a method of generating taint information in an operand register according to embodiments;

FIG. 9 is a diagram for explaining a method of generating input data information and taint information in an operand register according to embodiments;

FIG. 10 is a diagram for explaining a method of generating taint information in an operand register according to embodiments;

FIG. 11 is a diagram for explaining a method of generating taint information in an operand register according to embodiments;

FIG. 12 is a block diagram of an apparatus for tracking the location of the cause of a vulnerability according to an embodiment;

FIG. 13 is a block diagram illustrating the detailed configuration of an element described with reference to FIG. 12; and

FIG. 14 illustrates the hardware configuration of an apparatus for tracking the location of the cause of a vulnerability according to an embodiment.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

It will be understood that the terms “comprise” and/or “comprising” when used herein, specify some stated components, steps, operations and/or elements, but do not preclude the presence or addition of one or more other components, steps, operations and/or elements.

The location of the cause of a binary vulnerability may be a location where input data that causes a vulnerability in a binary was input. In the present specification, a method of tracking the location of input data that causes a vulnerability such as an error or a collision in a binary among data input to the binary will be described.

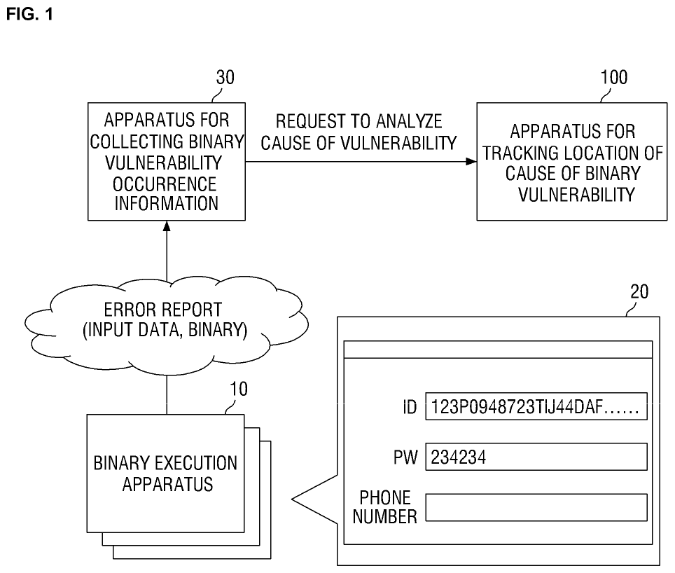

FIG. 1 illustrates the configuration of a system for tracking the location of the cause of a binary vulnerability according to an embodiment. Referring to FIG. 1, the system for tracking the location of the cause of a binary vulnerability includes a binary execution apparatus 10 and an apparatus 100 for tracking the location of the cause of a binary vulnerability.

The binary execution apparatus 10 may load a binary into a memory and execute the binary.

The apparatus 100 for tracking the location of the cause of a binary vulnerability may analyze error occurrence information when an error occurs in the binary execution apparatus 10 and find input data that causes a vulnerability existing in the binary. The binary execution apparatus 10 and the location tracking apparatus 100 may be provided as separate physical apparatuses or may be provided as separate modules within one apparatus.

The system for tracking the location of the cause of a binary vulnerability according to the current embodiment may further include an apparatus 30 for collecting binary vulnerability occurrence information.

The apparatus 30 for collecting binary vulnerability occurrence information may receive information about an error that occurs in the binary execution apparatus 10. For example, the information may include data input to a binary from the outside, the binary, and the type of the error.

The operation of the system for tracking the location of the cause of a binary vulnerability according to the current embodiment will now be described.

When external data is input to an interface 20 of a binary executed in the binary execution apparatus 10, an error may occur in the binary. For example, when a user inputs data about identification (ID), password (PW), and phone number to a binary, an error may occur in the binary due to the input data. However, it is difficult to find out exactly which of the various input data caused the error.

Therefore, the present disclosure includes the apparatus 30 for collecting binary vulnerability occurrence information in order to collect information about input data that caused an error in the binary execution apparatus 10. After the binary vulnerability occurrence information collecting apparatus 30 secures a test case of error causing data, the location tracking apparatus 100 capable of finding data that caused a binary error analyzes a binary. For example, when a buffer overflow occurs in the binary of FIG. 1, the location tracking apparatus 100 may obtain information indicating that the buffer size has been exceeded by data input as ID among the data input to the binary.

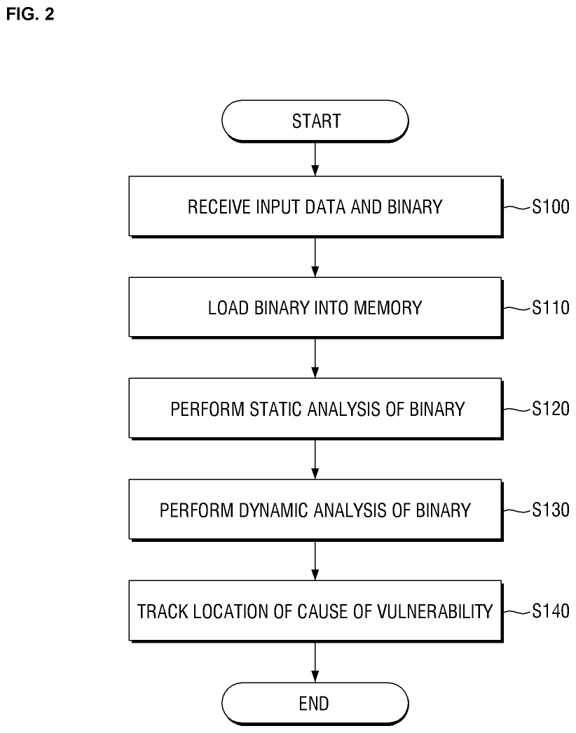

FIG. 2 is a flowchart illustrating a method of tracking the location of input data that causes a binary vulnerability according to an embodiment.

In operation S100, the apparatus 100 for tracking the location of the cause of a binary vulnerability may receive a binary and input data that causes a vulnerability in the binary. The input data may be data input from the outside when the binary is executed, for example, may be data input by a user or data input by a terminal. It should be noted that the input data refers to all data input from the outside when an error occurs in the binary and does not refer to specific data that causes the error.

In operation S110, the binary may be loaded into a memory in order to track the location of the cause of the vulnerability in the binary.

In operation S120, the binary may be statically analyzed to track the location of the cause of the vulnerability in the binary. The static analysis refers to analyzing the binary without executing the binary. For example, the static analysis may be performed using ANGR. ANGR is a Python library for analyzing binaries.

As the static analysis is performed, machine code of the binary may be converted into assembly language, and a header value may be obtained using the assembly language. The address of a symbol may be obtained using a symbol table existing in a header of the binary. In addition, a function that receives input data from the outside may be selected using the obtained address of the symbol. For example, there may be a scanf( ) function that reads data from stdin which is a standard input stream.

In the static analysis, a control flow graph (CFG) of the binary may also be generated by a CFG generator. The CFG may represent even the connection relationship between basic blocks existing in a function.

In operation S130, the binary may be dynamically analyzed to track the location of the cause of the vulnerability in the binary. The dynamic analysis refers to analyzing the binary while executing the binary. The dynamic analysis may be performed by, e.g., a GNU project debugger (GDB). The GDB is a debugger for analyzing a binary being executed.

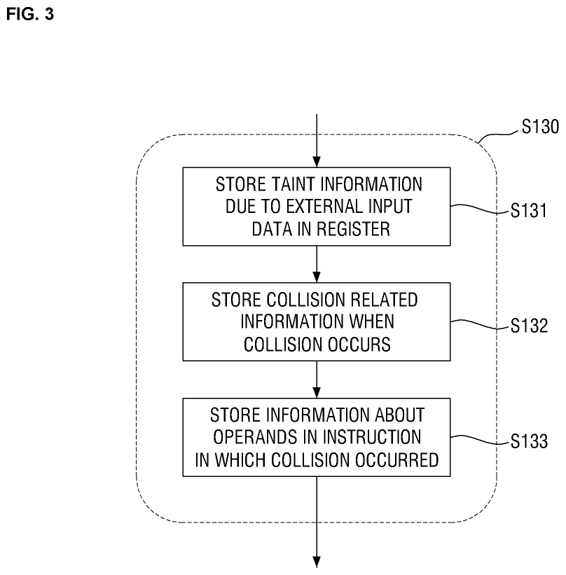

As the dynamic analysis is performed, the exact location of input data that caused the vulnerability in the binary can be found. This will be described in detail later with reference to FIG. 3.

The dynamic analysis and static analysis of the binary are not performed in a predetermined order and can be performed in parallel.

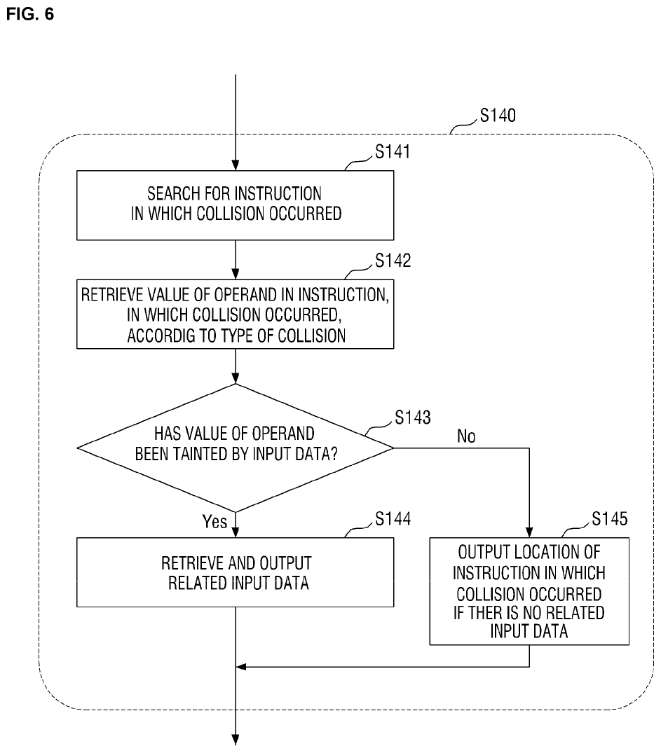

In operation S140, the exact location of the input data that caused the vulnerability may be tracked using the results of the static analysis and the dynamic analysis. This will be described in detail later with reference to FIG. 6.

FIG. 3 is a flowchart illustrating an operation of FIG. 2 in detail. A process of performing a dynamic analysis of the above binary to track the location of the cause of the vulnerability in the binary will be described in detail with reference to FIG. 3.

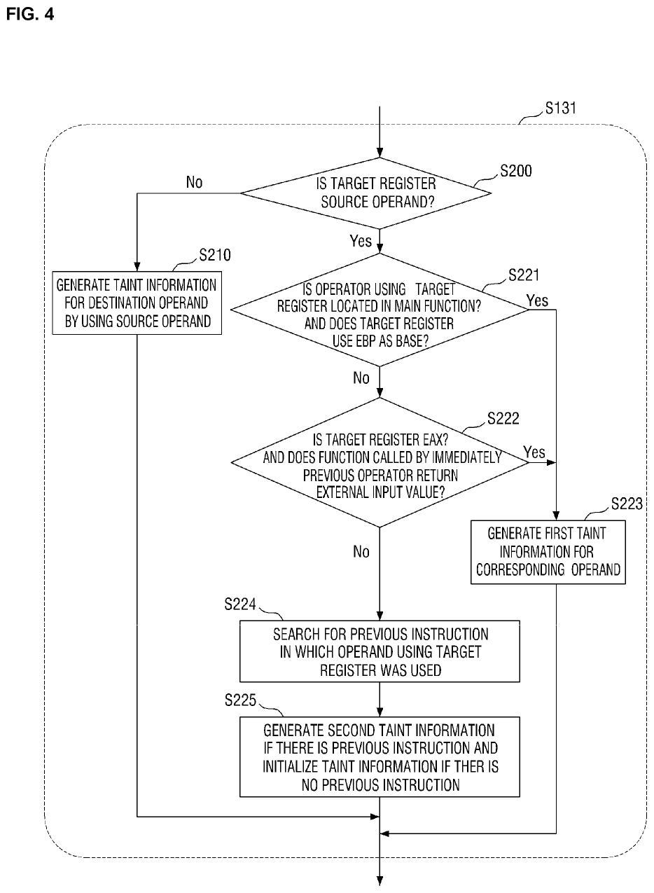

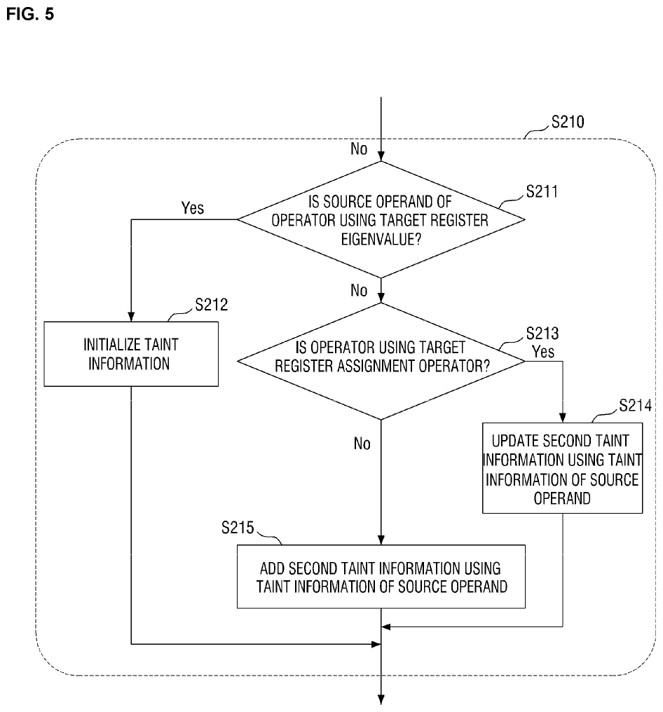

In operation S131, as the binary is executed, taint information due to external input data is recorded in a register. A method of recording the taint information in the register will be described in detail later with reference to FIGS. 4 and 5.

In operation S132, when a collision occurs during the execution of the binary, collision related information may be stored using a collision signal. For example, if a signal SGPE is generated, the cause of the collision may be “division by zero.” Therefore, the collision related information including the type and cause of the collision that occurred can be stored.

In operation S133, information about operands existing in an instruction in which the collision occurred may be stored. For example, if the collision occurred in an instruction “mov ecx, ebp,” information indicating that the collision occurred in an ecx register and an ebp register may be stored.

The stored collision related information and information about operands existing in the instruction in which the collision occurred may be used to select a target register, in which the location of input data that caused the collision is to be tracked, according to the type of the collision. This will be described in detail later with reference to FIG. 6.

FIG. 4 is a flowchart illustrating a method of generating taint information for a register of an operand in order to track the location of the cause of a binary vulnerability.

The method of generating taint information for a register of an operand may be, for example, a method of adding new taint information for the register of the operand or a method of modifying and updating existing taint information of the register of the operand. In addition, according to an embodiment, taint information may not be generated. Generated taint information may be stored in a separate database.

In operation S200, taint information for a register may be generated based on a different standard according to whether the type of an operand in which the register is used is a source operand or a destination operand.

First, a case where a target register whose taint information is to be generated is used in the source operand will be described.

If an instruction including an operator of a first operand register is included in a main function and a source operand of the operator has an address value in a relative addressing mode that uses ebp as a base in operation S221, first taint information may be added for the first operand register indicating the address value in operation S223.

For example, argc, which is a first argument of the main function, may be stored in an [ebp+8] address. In this case, the first operand register may be [ebp+8], and the first taint information storing information about argc may be added for [ebp+8].

In addition, if the first operand register is eax and an operator existing immediately before an operator in which a first operand is used is an operator that calls a function in operation S222, the first taint information may be added for the first operand in operation S223 if the called function is a function related to an external input value.

For example, if the called function is a function that receives an input value from a user through a scanf( ) function and returns data in which the input value is used, eax in which the returned data is stored may be the first operand register, and the first taint information that stores information about the input value received from the user may be added for the first operand register.

In operation S224, if the target register is not the first operand register, it is identified whether the target register was used in an operator before a first operator in which the first operand is used.

If it is identified in operation S224 that there is a second operator in which the target register was used, taint information of the target register used as an operand of the second operator may be used. In this case, the target register may be a second operand register, and, to generate second taint information, the same register as the target register used in the second operator may be used as the first operand register, and taint information of the first operand may be used as the first taint information. Therefore, the second taint information may be generated using the first taint information.

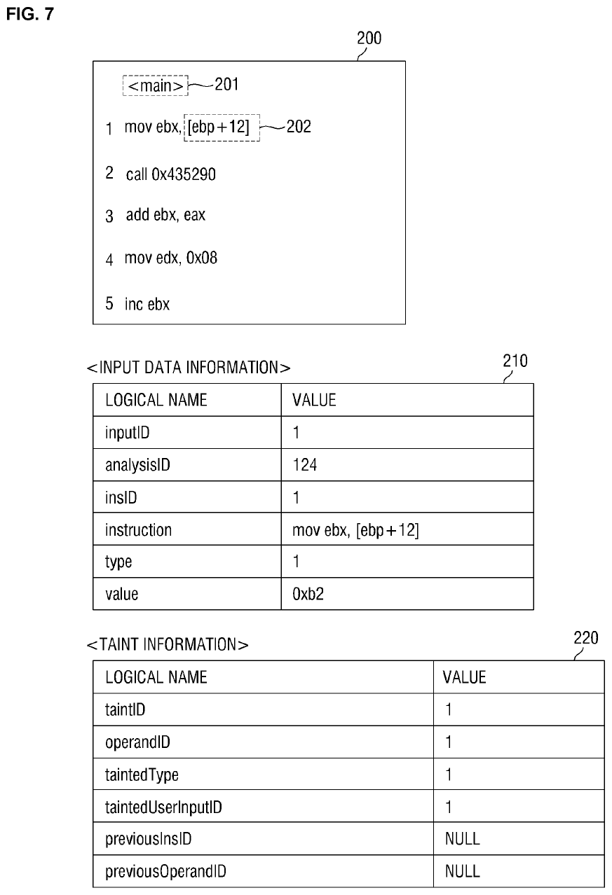

For example, if eax in a current instruction “mov edx, eax” was used in an instruction “push eax” existing before the current instruction, the second taint information for eax existing in the current instruction may be generated using the first taint information of eax previously used as an operand of a “push” operator. A detailed method of generating taint information will be described later with reference to FIGS. 7 through 11.

If the target register is the destination operand in operation S200, a method of generating taint information may be determined by a source operand used by an operator of the destination operand. This will now be described in detail with reference to FIG. 5.

FIG. 5 is a flowchart illustrating a method of generating taint information when the target register is the destination operand.

In operation S211, if the source operand of the operator in which the target register is used is an eigenvalue, there may be no taint information for the source operand. The eigenvalue may be, for example, a constant value.

For example, in the case of an instruction “move edx, 0x08,” if the target register is edx, the source operand is a constant 0x08. Therefore, no taint information may be assigned to the register for the source operand which is the constant.

In operation S212, if the source operand is an eigenvalue, taint information may be initialized because the target register which is the second operand register has not been tainted by other registers. If the taint information is initialized, no taint information may be generated.

In operation S213, if the source operand is not an eigenvalue, the target register which is the second operand register may be tainted by the source operand which is the first operand register. The target register may be tainted by modifying and updating the second taint information of the target register using the first taint information of the first operand register or by adding new second taint information.

The second taint information may be generated differently depending on the type of an operator in which the target register is used as the destination operand. For example, if the operator is an substitution operator such as mov, the second taint information may be updated using the first taint information in operation S214. Alternatively, if the operator is not an substitution operator, e.g., add, the taint information existing in the target register may be maintained, and the second taint information may be added using the first taint information in operation S215.

Operation S140 of FIG. 2 will now be described with reference to FIG. 6. FIG. 6 is a flowchart illustrating a method of tracking the exact location of input data that that caused a binary vulnerability using the generated taint information according to an embodiment.

In operation S141, if a collision occurs during the execution of the binary, an instruction in which the collision occurred may be searched for. For example, the collision may occur in an instruction “mov edx, eax.”

In operation S142, an operand whose taint information is to be retrieved may be determined according to the type of the collision. That is, an operand to be queried may be determined among a source operand and a destination operand existing in the instruction in which the collision occurred.

Types of collisions may include a collision due to a write operation, a collision due to a read operation, and a collision due to the execution of a function. In the case of the collision due to the write operation, taint information for the destination operand may be retrieved. In addition, in the case of the collision due to the read operation, taint information for the source operand may be retrieved. Lastly, in the case of the collision due to the execution of a function, taint information for an operand in the relative addressing mode that indicates a base index of the function may be retrieved.

In operation S143, it may be identified whether the retrieved taint information for the operand has been tainted by input data by tracing back the retrieved taint information. If the operand has been tainted by the input data, information about the input data may be retrieved and output in operation S144.

If it is identified in operation S143 that the retrieved taint information has not been tainted by the input data as a result of tracing back the taint information for the operand, the location of the instruction found in operation S141 as an instruction in which the collision occurred may be output in operation S143.

A method of storing taint information for an operand register according to an embodiment will now be described with reference to FIGS. 7 through 11.

When an operand register is affected by external input data, taint information may be generated for the operand register. The degree to which the operand register is affected by the external input data may be directly expressed as, e.g., an operator-operand relationship. In this case, if a source operand is the external input data, a destination operand may be a first operand register affected by the external input data.

In addition, the operand register may be affected by a branch statement from the external input data. For example, if a value for branching in the branch statement is the external input data or the operand register affected by the external input data, the external input data may have affected the value changed as a result of the branching.

However, if an eigenvalue is input to the operand register or replaced with a value not affected by the external input data, the operand register may have not been affected by the external input data.

When the external data is input, information about the input data may be recorded in order to generate taint information for the operand register. The information about the input data may include an initial input data value and an identification number for identifying each piece of input data. The taint information may include information about whether the operand register has been affected by the input data, information about a unique number of the input data that affected the operand register, and information about whether the operand register has been affected directly or indirectly by the input data.

According to embodiments, there may be a plurality of pieces of input data that affected the taint information.

A process of generating taint information for a register of an operand and information about input data will now be described in detail with reference to FIGS. 7 through 11.

In FIG. 7, an example binary assembly code 200 is illustrated. It can be seen that the binary assembly code 200 is assembly code of a main function 201. The assembly code is written in the order of “operator, destination operand, source operand” according to the Intel syntax.

In each instruction, an operand has a unique ID value. For example, in instruction 1, the ID of [ebp+12] may be 1, and the ID of ebx may be 2. In instruction 3, the ID of eax may be 3, and the ID of ebx may be 4. The ID of edx in instruction 4 may be 5, and the ID of ebx in instruction 5 may be 6.

Data input to the main function may be stored in [ebp+12] which is the source operand of instruction 1. Therefore, information 210 about the input data may be generated, and taint information 220 for [ebp+12] may be newly generated.

That is, [ebp+12] is a register of the source operand, the location of instruction 1 in which [ebp+12] is used is the main function, and [ebp+12] has an address value in the relative addressing mode that uses ebp as a base. Therefore, [ebp+12] may be a register first tainted by the data input to the main function. Accordingly, first taint information may be added for [ebp+12].

The input data information 210 may include inputID which is a unique number of the input data, insID which is a unique number of an instruction first tainted by the input data, an instruction item which stores an operator and an operand of the instruction, a value item which stores a value of the input data, etc.

For example, when 0xb2 is input to the main function as input data, the input data information 210 may be generated for the input data. In this case, inputID is 1 based on the assumption that the input data is data input for the first time, insID is 1 because the instruction first tainted by the input data is instruction 1, “mov ebx, [ebp+12]” which are the operator and the operand of instruction 1 are stored in the instruction item, and 0xb2 which is the value of the input data is stored in the value item.

In addition, the taint information 220 for an operand register may include taintID which is a unique number of taint information, operandID which is a unique number of an operand, taintedType which is a number indicating the type of the taint information, taintedUserinputID which is a unique number of input data that tainted the operand register and that is stored in the input data information 210, previousInsID which is a unique number of an instruction in which the operand register was used before a current instruction, and previousOperandID which is a unique number of an operand register on which an operation was executed before the current operand register.

For example, in FIG. 7, taint information generated for a register 202 first tainted by the input data of the main function has 1 as taintID and does not have previousInsID and previousOperandID. In addition, 1 which is the ID of 0x62 of the input data is stored in taintedUserinputID, and 1 which is the ID of [ebp+12] 202 is stored in operandID.

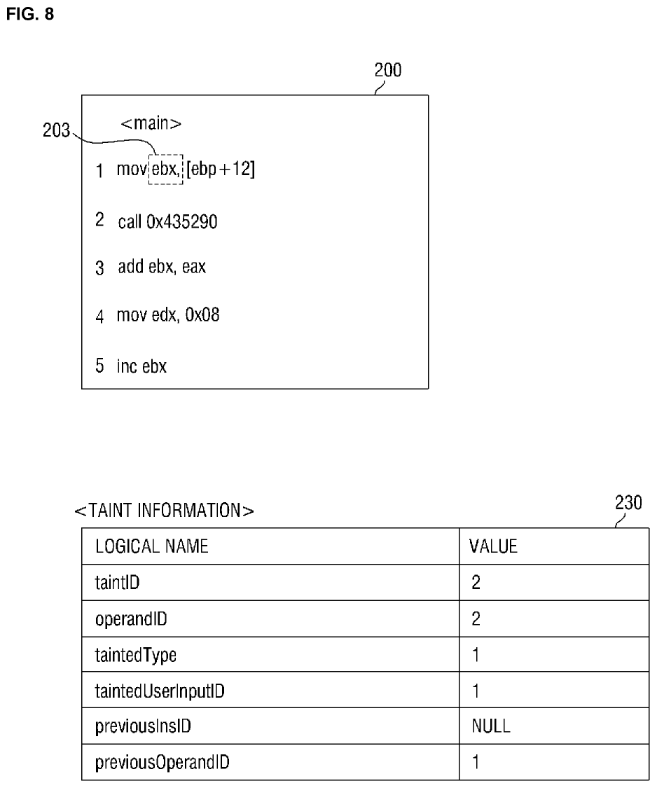

A method of updating taint information of a destination operand register using taint information of a register of a source operand will be described with reference to FIG. 8.

Ebx is a destination operand register, [ebp+12] which is a source operand register is not a constant value, and an operator is mov. Therefore, second taint information of ebx may be updated using first taint information of [ebp+12].

If ebx 203 is tainted by [ebp+12], taint information 203 of ebx may be generated as follows. TaintID which is a unique number of taint information may be 2, operandID which is a unique number of ebx may be 2, and taintedUserInputID may be 1 because input data that affected ebx is the same as input data that affected [ebp+12]. In addition, previousID may be null because an instruction in which ebx is used is a first instruction, and previousOperandID may be 1 which is the ID of [ebp+12] because an operand computed before ebx is [ebp+12].

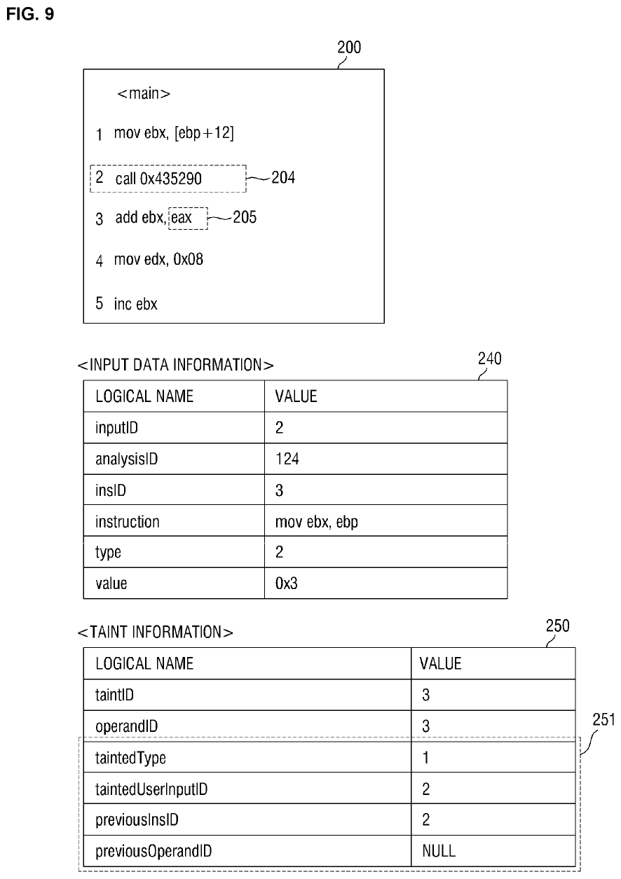

A method of generating taint information of a source operand register tainted by a function that returns input data will be described with reference to FIG. 9.

If a first operand register is first tainted by a function that returns input data of an error-causing case, first taint information may be added for the first operand register.

For example, if a function called by instruction 2 and existing at an address of 0x435290 returns external data having a value of 0x3, input data information 240 may be generated for the input data. InputID may be 2 because the input data is data input for the second time, and insID may be 3 because an instruction first tainted by the input data is instruction 3, “add ebx, eax” which are the operator and the operand of instruction 3 may be stored in the instruction item, and 0x03 which is the value of the input data may be stored in the value item.

In addition, taint information may be generated for a register 205 first tainted by the input data returned by the function. TaintID which is a unique number of taint information may be 3, operandID which is a unique number of eax existing in register 3 may be 3, 2 which is inputID of the input data 0x3 may be stored in taintedUserinputID, and 2 may be stored in previousInsID to indicate instruction 2 computed before instruction 3 including eax. In particular, since eax is a register first tainted by the returned value of the function, previousOperandID may be null to indicate that eax has not been tainted by other operand registers.

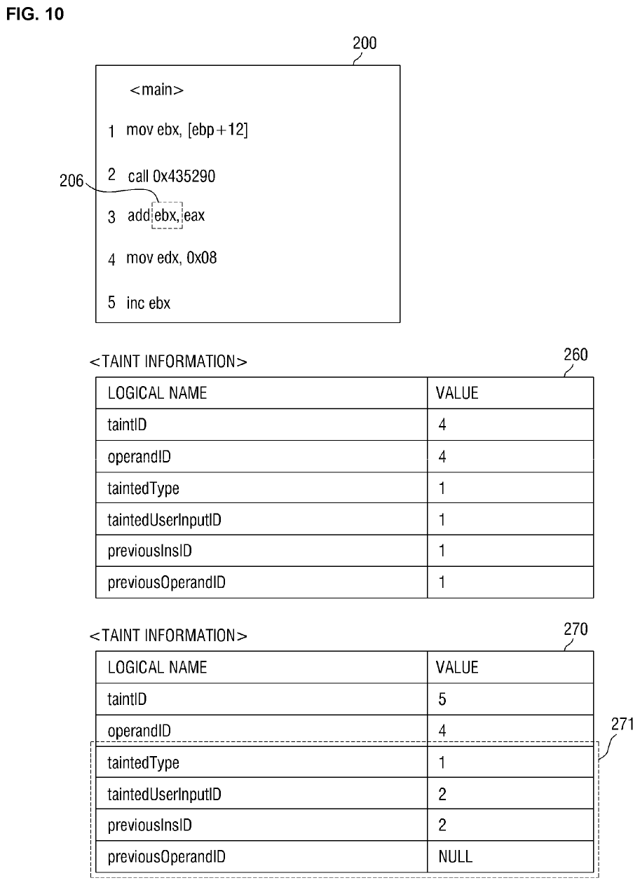

A method of adding taint information of a destination operand register using taint information of a source operand register will now be described with reference to FIG. 10.

Ebx is a destination operand register 206, eax which is a source operand register is not a constant value, and an operator is add which is not an substitution operator. Therefore, second taint information of ebx may be added using first taint information of eax. In this case, the second taint information is not updated as in the case where the operator is an substitution operator in FIG. 8. Instead, new taint information 270 is added while existing taint information 260 is maintained.

According to embodiments, an operand register may have a plurality of pieces of taint information. That is, it should be noted that one operand register can be tainted by a plurality of pieces of input data.

If ebx 206 is tainted by eax, the taint information 260 and 270 of ebx may be generated as follows.

First, the taint information 260 of ebx generated in instruction 1 may be maintained. Therefore, taintedType and taintedUserinputID which are information indicating that ebx was tainted by [ebp+12] in instruction 1 are maintained as they are. In addition, 1 may be stored as previousInsID because an instruction in which ebx was previously used is instruction 1, and 1 which is operandID of [ebp+12] may be stored as previousOperandID because an operand register computed before ebx is [ebp+12] in the case where ebx is tainted by [ebp+12].

Next, the taint information 270 of ebx may be added due to eax in instruction 3. TaintID which is a unique number of taint information may be 5, and operandID which is a unique number of ebx may be 4. In addition, since ebx was tainted by eax, taint information of eax may be used for taintedType, taintedUserinputID, previousInsID, and previousOperatndID as indicated by reference numeral 271.

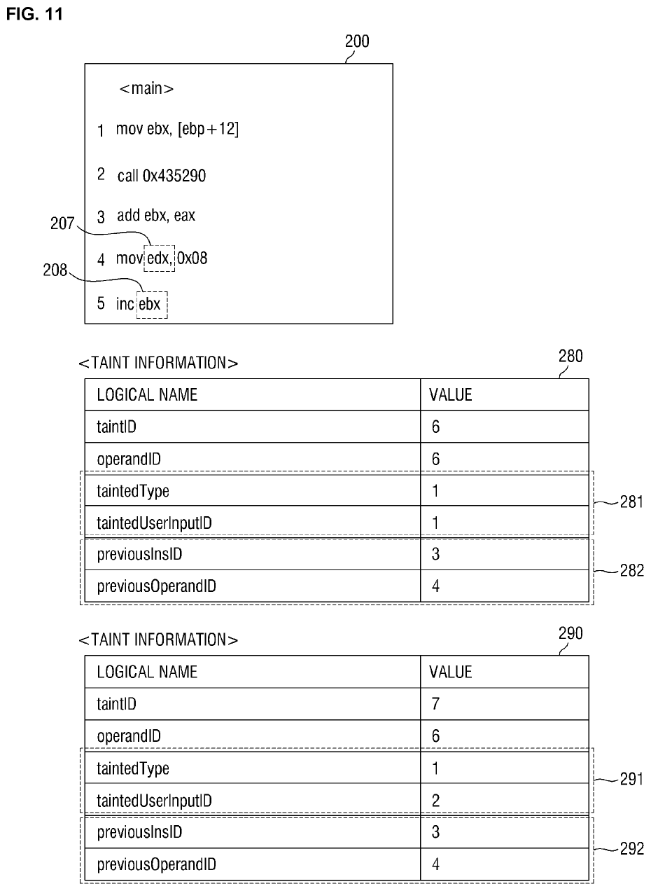

In FIG. 11, edx 207 of instruction 4 is a destination operand register, and a source operand has an eigenvalue. Therefore, taint information may not be generated. Even if a destination operand is affected by the eigenvalue, since the eigenvalue is not new input data, the eigenvalue cannot be the cause of an error that occurs during the execution of a binary. Therefore, taint information is not generated. Accordingly, taint information that stores 5 as operandID may not be generated.

Taint information of ebx 208 of instruction 5 may be updated as follows. Since the ebx 208 has not been affected, taint information 281 and 291 related to the existing input data may be maintained. However, taint information 280 and 290 may be generated by updating operandID to 6 and updating taintID. In addition, since ebx was used in instruction 3 existing before instruction 5, 3 may be stored in previousInsID, and 4 which is operandID of ebx in instruction 3 may be stored in previousOperandID as indicated by reference numerals 282 and 292.

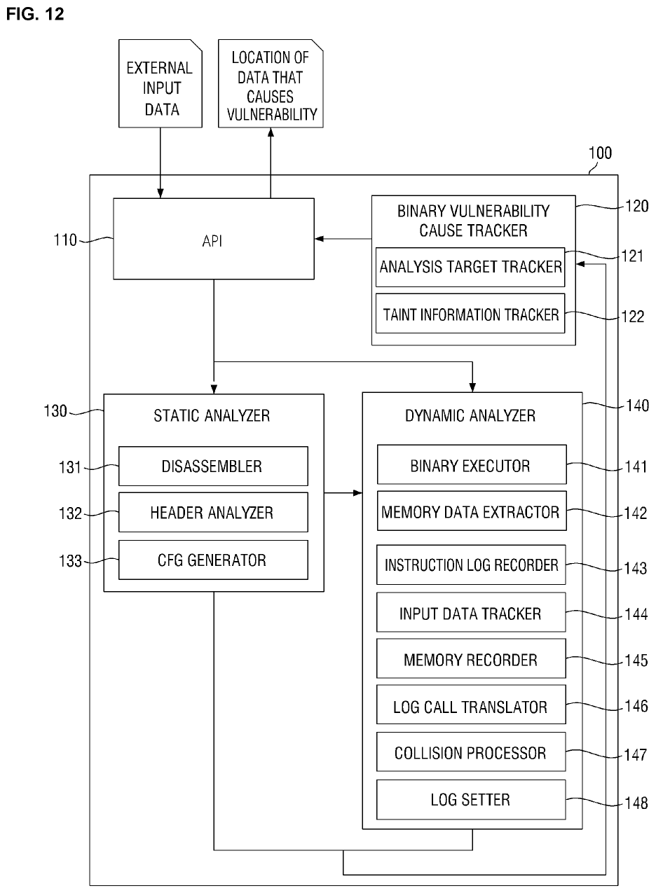

The configuration and operation of an apparatus 100 for tracking the location of the cause of a binary vulnerability according to an embodiment will now be described with reference to FIG. 12. Referring to FIG. 12, the apparatus 100 for tracking the location of the cause of a binary vulnerability according to the current embodiment may include at least one of an application programming interface (API) 110, a binary vulnerability cause tracker 120, a static analyzer 130, and a dynamic analyzer 140.

The API 110 refers to a software or hardware module that mediates data input to the location tracking apparatus 100 or output from the location tracking apparatus 100. According to an embodiment, a binary and external data that causes a vulnerability in the binary may be input to the location tracking apparatus 100, and information about the location of exact data that causes the vulnerability and the data may be output from the location tracking apparatus 100.

The binary vulnerability cause tracker 120 may include at least one of an analysis target tracker 121 and a taint information tracker 122.

When a collision occurs during the execution of a binary, the analysis target tracker 121 may search for an instruction in which the collision occurred. In addition, the analysis target tracker 121 may select an operand in the instruction as an analysis target according to the type of the collision.

The taint information tracker 122 may obtain information about input data by tracing back taint information of the operand register selected as the analysis target by the analysis target tracker 121. The obtained information about the input data may be sent to the API 110 and may be finally output.

The static analyzer 130 may include at least one of a disassembler 131, a header analyzer 132, and a CFG generator 133.

The disassembler 131 may convert machine code of a binary, the location of the cause of whose vulnerability is to be tracked, into assembly language.

The header analyzer 132 may read a header value from file information of the binary converted into the assembly language and obtain the address of a symbol from information of a symbol table existing in a header. The symbol table may be, for example, a debugging symbol table. In addition, the symbol table may include a function table that stores function information. A function call translator 146 of the dynamic analyzer 140 may compare the obtained address of the symbol with a function and a library called in the binary and determine whether the function and the library are a function and a library related to input data.

The CFG generator 133 may generate a CFG that represents even the connection relationship between basic blocks existing in a function of the binary. Thus, the CFG generator 133 may be operated after the disassembler 131 and the header analyzer 132. In addition, the generated CFG may be converted into a normalized form.

The dynamic analyzer 140 may include at least one of a binary executor 141, a memory data extractor 142, an instruction log recorder 143, an external input data tracker 144, a memory recorder 145, the function call translator 146, a collision processor 147, and a log setter 148.

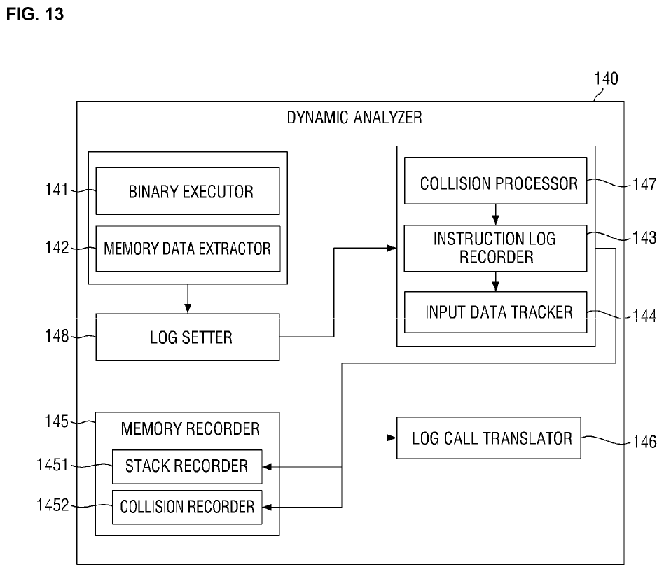

The dynamic analyzer 140 will now be described in detail with reference to FIG. 13.

First, the binary executor 141 may execute and control a binary. When an error occurs, the binary executor 141 may generate a signal and transmit the generated signal to the collision processor 147.

The memory data extractor 142 may extract register and memory information during the execution of the binary.

The log setter 148 may set elements to be recorded and a recording range in order to reduce the load when all information generated during the execution of the dynamic analyzer 140 is recorded. For example, a recording time, elements to be recorded, and a recording category for each function may be set.

The recording time may be set by designating a recording start time and a recording end time. The recording start time may be a time when the execution of a binary starts, a time when a main function or a user-defined function is called, or a time when the user-defined function or an instruction is executed.

The recording start time may be the time when the execution of a binary starts, for example, if there is no function information due to the absence of a debugging symbol. If the time when the main function or the user-defined function is called is the recording start time, recording may start from an area where a function excluding a function created by a compiler is executed.

The recording end time may be an end time of the binary, an end time of the main function, or an end time of the user-defined function. In addition, a function or instruction for designating the recording end time may be designated.

The collision processor 147 may cause collision information to be generated when a collision occurs. The collision processor 147 may process the collision when detecting a signal transmitted from the binary executor 141. The cause of the collision according to the signal may be as shown in the following table.

TABLE 1

| Signal | Cause |
|---|---|
| SIGFPE | Division by zero |
| SIGSEGV, SIGBUS | Invalid memory read/write/access |
| | Stack overflow |
| | Invalid memory access |
| SIGABRT | Program abort |
| SIGCHLD | Child process exit |

The collision processor 147 may transmit information about an instruction in which the collision occurred to the instruction log recorder 143 and may request the memory recorder 145 to generate the collision information so that a collision recorder 1452 can record the collision signal.

The instruction log recorder 143 may record a value indicated by eip which is a register indicating an instruction to be executed next. A value indicated by an operator, an operand and an operand register of an instruction may be recorded using a memory value of an address indicated by eip. For example, an operand value may be obtained through an udis86 disassembler.

In addition, a different module may be called according to the type of operator existing in an instruction. For example, if the operator is push, pop, call or ret, a stack recorder 1451 of the memory recorder 145 may be called. In addition, if the debugging symbol and the eip value match, the function call translator 146 may be called. If the instruction is an INT 3 instruction, the function call translator 146 may also be called.

The input data tracker 144 may record an object affected by input data that appears after the main function. That is, input data before the main function may not be tracked. The input data may include a value called as a parameter in the main function and a value input through a function that receives the input data.

The function call translator 146 may record a called function, a parameter used for calling, and a value returned by the function. In addition, the function call translator 146 may compare a symbol recorded in the static analysis with the called function.

The memory recorder 145 may further include any one of the stack recorder 1451 and the collision recorder 1452.

The recording category and the recording timing of the stack recorder 1451 may be changed by the log setter 148.

The recording category may be, for example, esp and ebp values or the entire stack area. The recording timing may be in the case of push, pop, ret and call operators or all instructions.

The collision recorder 1452 may record a collision memory when receiving a request to record a collision from the collision processor 147.

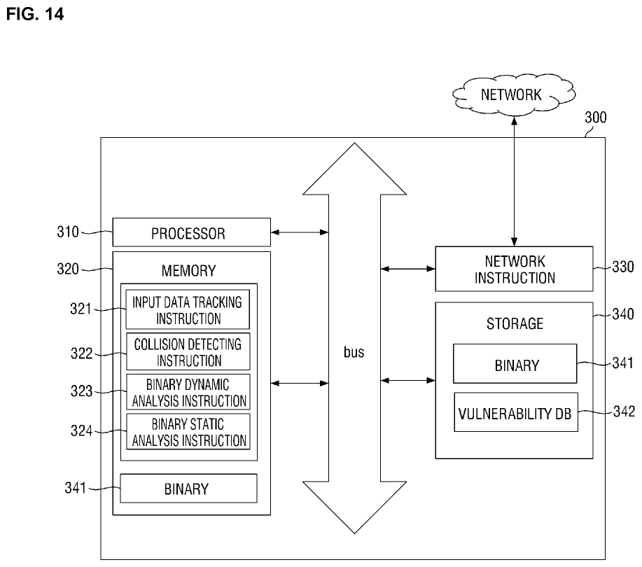

FIG. 14 illustrates the hardware configuration of an apparatus 300 for tracking the location of the cause of a binary vulnerability according to an embodiment.

Referring to FIG. 14, the apparatus 300 for tracking the location of the cause of a binary vulnerability according to the current embodiment may include a processor 310 and a memory 320 and may further include at least one of a storage 340, a network interface 330, and a system bus in some embodiments.

One or more instructions loaded and stored in the memory 320 are executed by the processor 310. It should be noted that, although not specifically described, the apparatus 300 for tracking the location of the cause of a binary vulnerability according to the current embodiment can perform operations related to the method of tracking the location of the cause of a binary vulnerability described above with reference to FIGS. 1 through 13.

The network interface 330 may receive a binary 341 and a vulnerability database 342 which causes a collision during the execution of the binary 341 from an external apparatus through a network and may allow the binary 341 and the vulnerability database 342 to be stored in the storage 340.

The above instructions may include an instruction 321 for loading the binary 341 into the memory 320 and tracking input data that causes a vulnerability, an instruction 322 for detecting whether a collision has occurred in the binary 341, an instruction 323 for performing a dynamic analysis of the binary 341, and an instruction 324 for performing a static analysis of the binary 341.

In an embodiment, the input data tracking instruction 321 may track input data that causes a vulnerability using taint information stored in a register of assembly code of the binary 341 stored in the storage 340.

In an embodiment, when a collision occurs during the execution of the binary 341, the collision detecting instruction 322 may detect the collision and record an instruction in which the collision occurred. The operation of the input data tracking instruction 321 may start with taint information of an operand register existing in the above instruction.

In an embodiment, the binary dynamic analysis instruction 324 may analyze the binary 341 during the execution of the binary 341. The binary dynamic analysis instruction 324 may generate taint information in a register used in the binary 341.

In an embodiment, the binary static analysis instruction 324 may analyze information for dynamic analysis before the binary 341 is executed. The binary static analysis instruction 324 may analyze a function that receives input data among functions existing in the binary 341.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

What is claimed is:

1. A method of tracking the location of the cause of a binary vulnerability, the method being performed by a computing apparatus and comprising:
adding first taint information to a first operand register tainted by input data of an error-causing case;
generating second taint information for a second operand register by using the first taint information, wherein the second operand register is tainted by the input data of the first operand register; and
tracking at least one of a plurality of pieces of the input data that caused an error among the input data of the error-causing case by tracing back taint information for each register of each operand to where the error initially occurred.

2. The method of claim 1, wherein adding the first taint information to the first operand register tainted by the input data of the error-causing case comprises adding first taint information for a register of a source operand, wherein the first operand register is the source operand.

3. The method of claim 2, wherein adding the first taint information to the first operand register tainted by the input data of the error-causing case further comprises adding the first taint information for the first operand register, and wherein the first operand register is first tainted by the input data of the error-causing case input from a main function.

4. The method of claim 3, wherein adding the first taint information to the first operand register tainted by the input data of the error-causing case further comprises adding the first taint information for the first operand register indicating an address value of a relative addressing mode that uses ebp as a base, wherein an operator of the first operand register is included in the main function, and wherein a source operand of the operator is the address value.

5. The method of claim 2, wherein adding the first taint information to the first operand register tainted by the input data of the error-causing case further comprises adding the first taint information to the first operand register, wherein the first operand register is first tainted by a function that returns the input data of the error-causing case.

6. The method of claim 5, wherein adding the first taint information to the first operand register tainted by the input data of the error-causing case further comprises adding the first taint information for the first operand register, wherein the first operand register is eax, and wherein an operator immediately before the operator of the first operand register is an operator calling a function that returns the input data of the error-causing case.

7. The method of claim 6, wherein adding the first taint information to the first operand register tainted by the input data of the error-causing case further comprises:
extracting a function that returns the input data of the error-causing case by analyzing a symbol table stored in a header of a binary, the location of the cause of whose vulnerability is to be tracked; and
adding the first taint information for the first operand register, wherein the function called by the operator immediately before the operator of the first operand register is the same as the function extracted by analyzing the symbol table stored in the header of the binary.

8. The method of claim 1, wherein generating the second taint information for the second operand register by using the first taint information comprises updating the second taint information using the first taint information generated for the second operand register of a second operator, wherein the second operand register is a source operand, and wherein the second operand register was used in the second operator existing before a first operator of the second operand register.

9. The method of claim 1, wherein generating the second taint information for the second operand register by using the first taint information comprises not generating the second taint information if the second operand register is a source operand, and wherein the second operand register was not used in the second operator existing before the first operator of the second operand register.

10. The method of claim 1, wherein generating the second taint information for the second operand register by using the first taint information comprises generating the second taint information for the second operand register by using the first taint information of a source operand, and wherein the second operand register is a destination operand.

11. The method of claim 10, wherein generating the second taint information for the second operand register by using the first taint information further comprises not generating the second taint information, and wherein the source operand is a constant value.

12. The method of claim 10, wherein generating the second taint information for the second operand register by using the first taint information further comprises updating the second taint information using the first taint information, wherein the source operand is different from a constant value, and wherein an operator of the second operand register is a substitution operator.

13. The method of claim 10, wherein generating the second taint information for the second operand register by using the first taint information further comprises adding second taint information using first taint information, wherein the source operand is different from a constant value, and wherein the operator of the second operand register is different from a substitution operator.

14. The method of claim 1, wherein tracking at least one of a plurality of pieces of the input data that caused the error among the input data of the error-causing case by tracing back the taint information for each register of each operand to where the error initially occurred comprises tracking the input data that caused the error by using taint information of an operand register existing in an instruction at the point where the error occurred according to the type of the error.

15. The method of claim 14, wherein tracking at least one of a plurality of pieces of the input data that caused the error among the input data of the error-causing case by tracing back the taint information for each register of each operand to where the error initially occurred further comprises tracking the input data that caused the error by using taint information of a destination operand of the instruction, and wherein the error is an error caused by a write operation.

16. The method of claim 14, wherein tracking at least one of a plurality of pieces of the input data that caused the error among the input data of the error-causing case by tracing back the taint information for each register of each operand to where the error initially occurred further comprises tracking the input data that caused the error by using taint information of a source operand of the instruction, and wherein the error is an error caused by a read operation.

17. The method of claim 14, wherein tracking at least one of a plurality of pieces of the input data that caused the error among the input data of the error-causing case by tracing back the taint information for each register of each operand to where the error initially occurred further comprises tracking the input data that caused the error by using taint information of a register indicating a base index of a function, and wherein the error is an error caused by the execution of the function.

18. A computing apparatus comprising:
a memory into which a binary analysis program is loaded; and
a processor which executes the binary analysis program loaded into the memory,
wherein the binary analysis program comprises:
an instruction for adding first taint information to a first operand register tainted by input data of an error-causing case;
an instruction for generating second taint information for a second operand register by using the first taint information, wherein the second operand register is tainted by data of the first operand register; and
an instruction for determining at least one of a plurality of pieces of the input data that caused an error among the input data of the error-causing case by tracing back taint information for each register of each operand to where the error initially occurred.
